(19) United States
(12) Patent Application Publication
(10) Pub. No.: US 2015/0305090 A1
(43) Pub. Date: Oct. 22, 2015

(54) Portable Heating Device

(71) Applicant: Juan R. Vargas, Los Angeles, CA (US)

(72) Inventor: Juan R. Vargas, Los Angeles, CA (US)

(21) Appl. No.: 14/254,983

(22) Filed: Apr. 17, 2014

(51) Int. Cl. H05B 1/02; H01M 10/46; H05B 3/06

(52) U.S. Cl. CPC H05B 1/0275; H05B 3/06; H01M 10/465

(57) ABSTRACT

A portable heating device stores and warms food items positioned therein. The device includes a housing. The housing includes a main body having a bottom wall and a perimeter wall attached to and extending upwardly from the bottom wall. A top edge of the perimeter wall defines an access opening into an interior of the main body. At least one dividing wall extends through the interior of the main body defining a plurality of chambers each receiving food items therein. A lid is positionable to close the access opening and cover each of the chambers. A heating element is mounted within the housing and is positioned below each of the chambers for heating the food items positioned in each of the chambers. A power source is coupled to the housing and electrically coupled to the heating element for providing power to heat the heating element.

### BACKGROUND OF THE DISCLOSURE

### FIELD OF THE DISCLOSURE

The disclosure relates to heating devices and more particularly pertains to a new heating device for storing and warming food positioned therein.

### SUMMARY OF THE DISCLOSURE

An embodiment of the disclosure meets the needs presented above by generally comprising a housing. The housing includes a main body having a bottom wall and a perimeter wall attached to and extending upwardly from the bottom wall. A top edge of the perimeter wall defines an access opening into an interior of the main body. At least one dividing wall extends through the interior of the main body defining a plurality of chambers each configured for receiving food items therein. A lid is positionable to close the access opening and cover each of the chambers. A heating element is mounted within the housing and is positioned below each of the chambers for heating the food items positioned in each of the chambers. A power source is coupled to the housing and electrically coupled to the heating element for providing power to heat the heating element.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a portable heating device according to an embodiment of the disclosure.

FIG. 2 is a front perspective view of an embodiment of the disclosure showing the lid detached from the housing.

FIG. 3 is a side view of an embodiment of the disclosure.

FIG. 4 is a top view of an embodiment of the disclosure showing the lid being opened.

FIG. 5 is a bottom view of an embodiment of the disclosure.

FIG. 6 is a cross-sectional view of an embodiment of the disclosure taken along line 6-6 of FIG. 1.

FIG. 7 is a top front side perspective view of a pair of alternative embodiments of the disclosure.

FIG. 8 is a cross-sectional view of an alternative embodiment of the disclosure taken along line 8-8 of FIG. 7.

FIG. 9 is a cross-sectional view of an alternative embodiment of the disclosure taken along line 9-9 of FIG. 7.

### DESCRIPTION OF THE PREFERRED EMBODIMENT

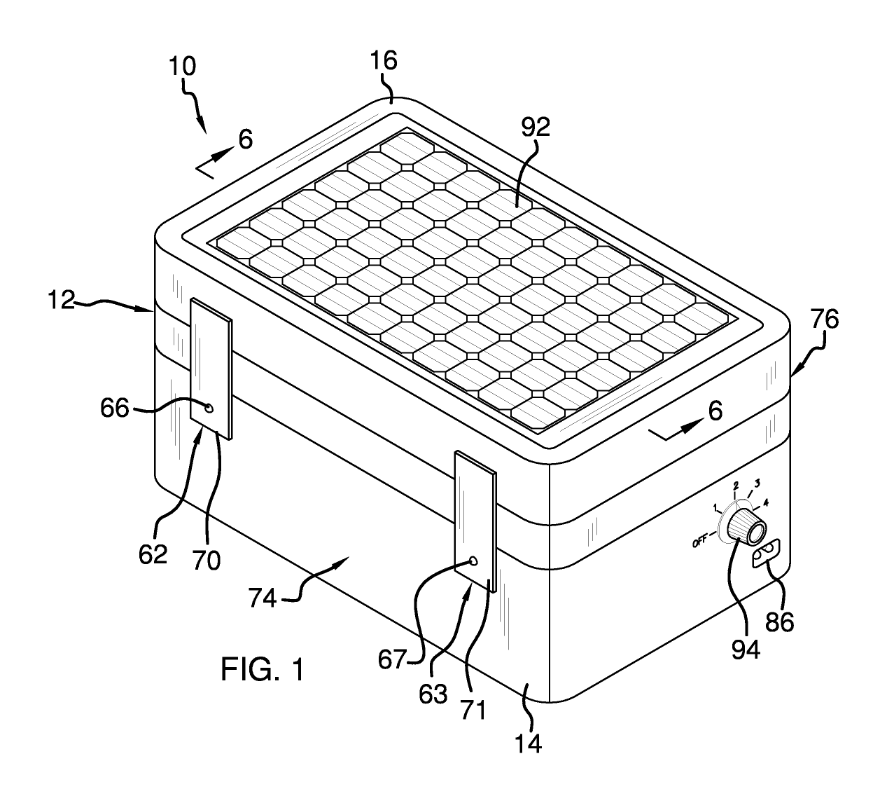

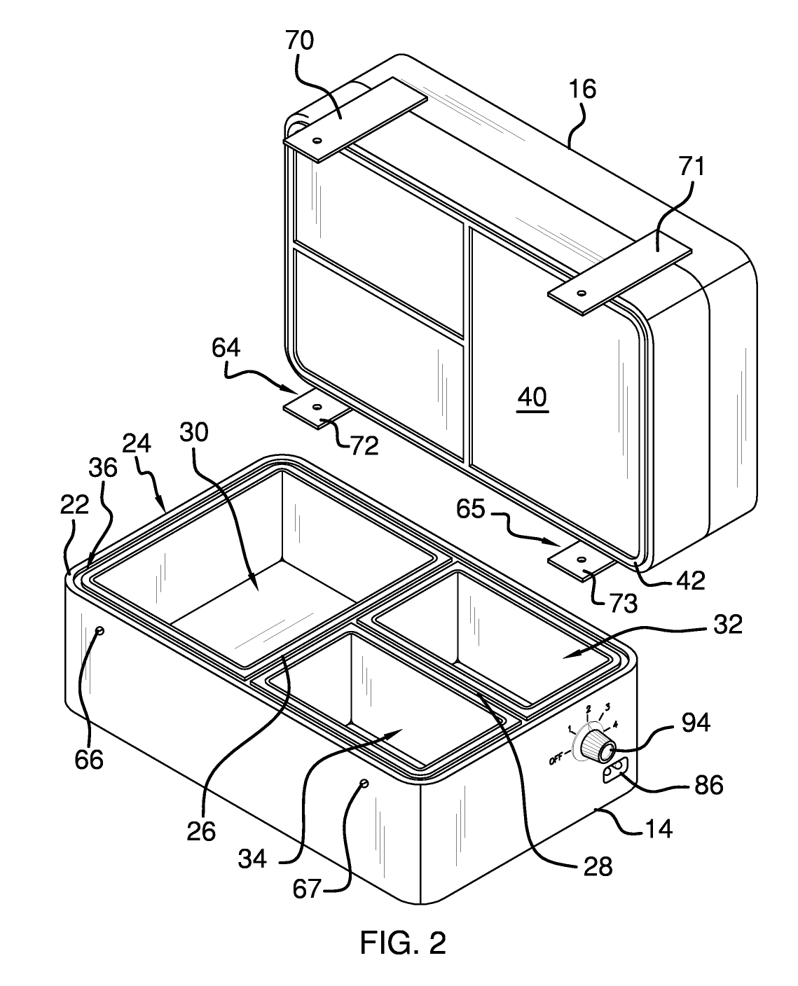

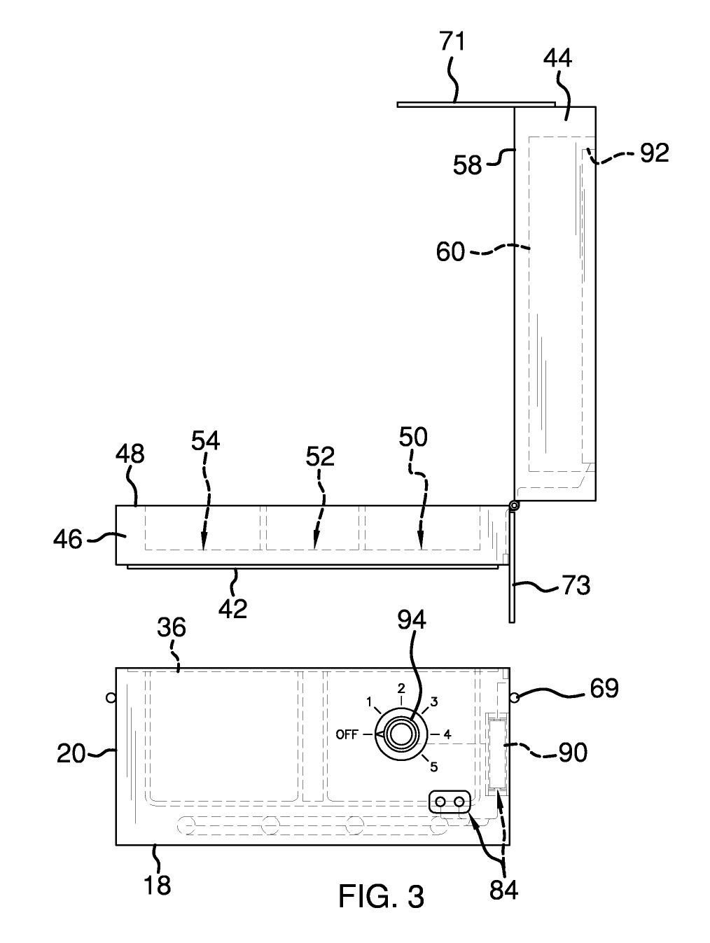

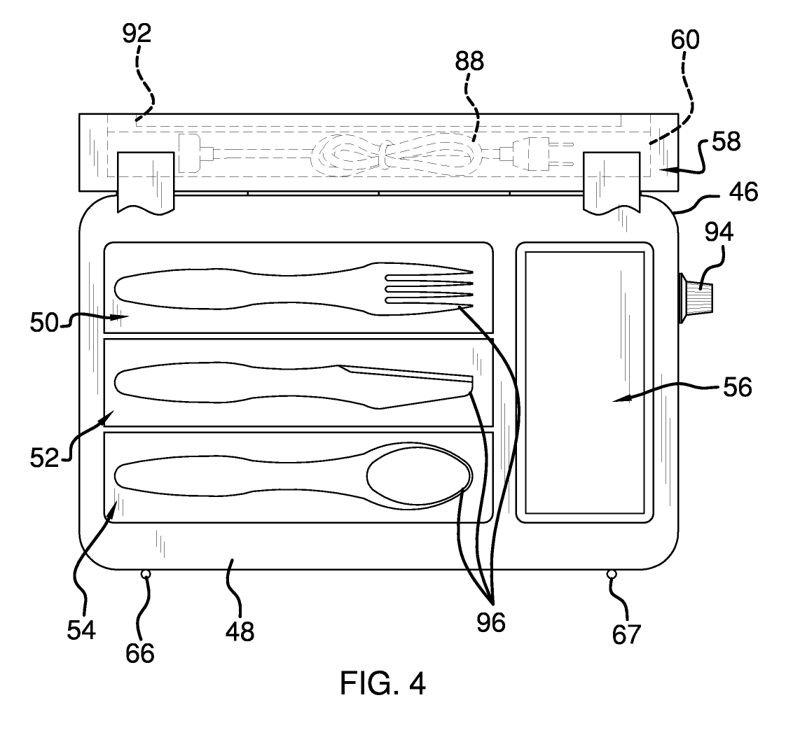

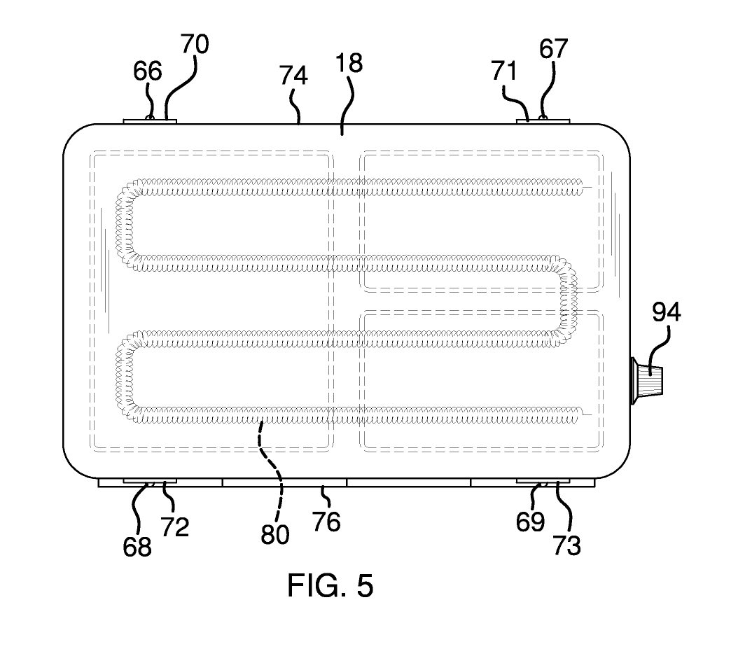

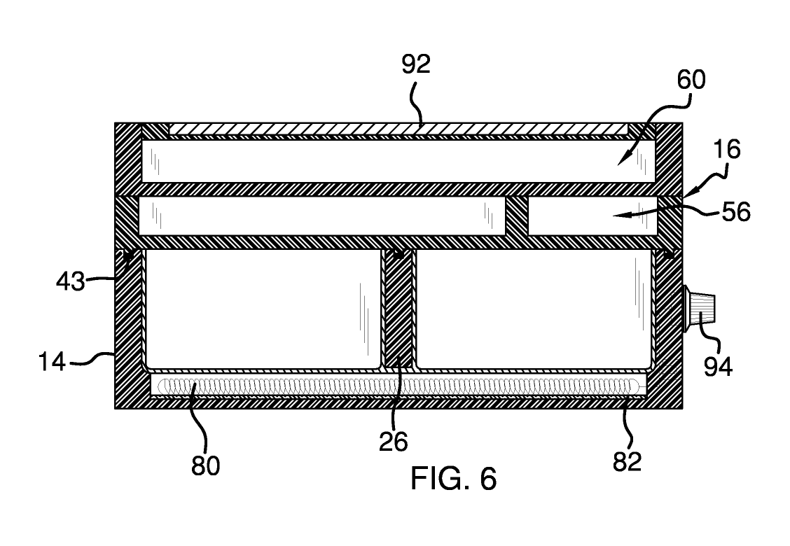

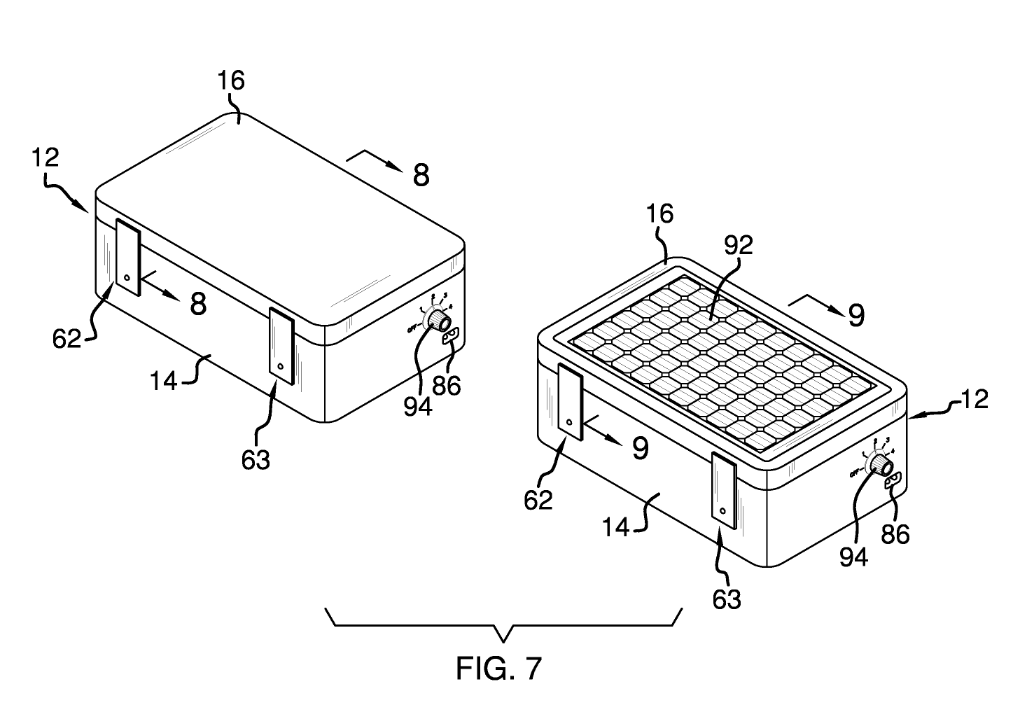

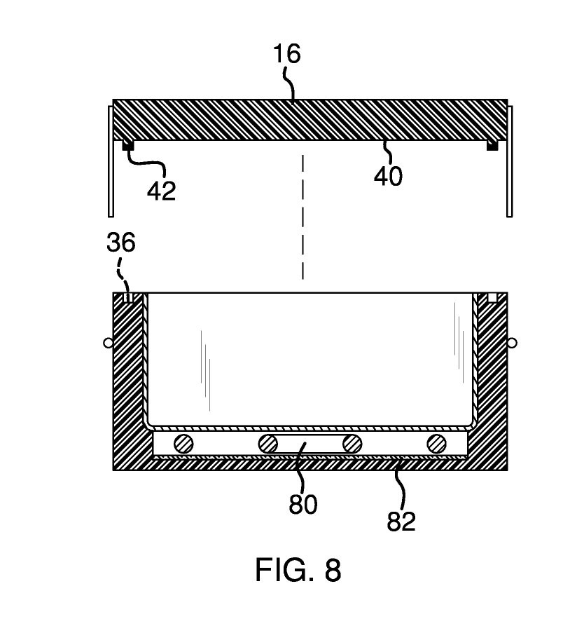

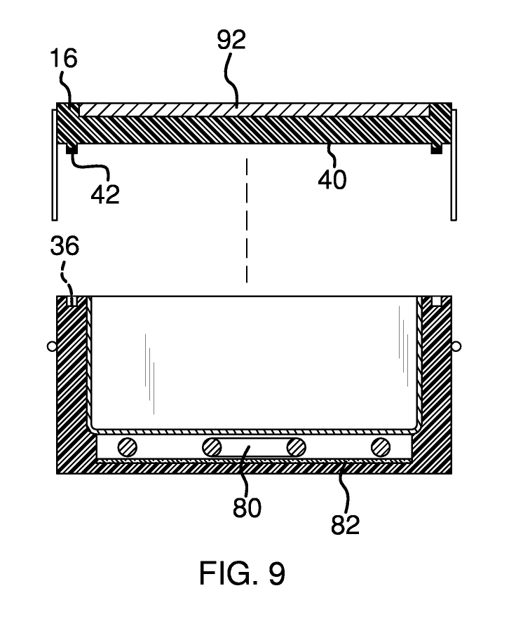

With reference now to the drawings, and in particular to FIGS. 1 through 9 thereof, a new heating device embodying the principles and concepts of an embodiment of the disclosure and generally designated by the reference numeral 10 will be described.

As best illustrated in FIGS. 1 through 9, the portable heating device 10 generally comprises a housing 12 including a main body 14 and a lid 16. The housing 12 may have a generally rectangular configuration. The main body 14 has a bottom wall 18 and a perimeter wall 20 attached to and extending upwardly from the bottom wall 18. A top edge 22 of the perimeter wall 20 defines an access opening 24 into an interior of the main body 14. At least one dividing wall 26, 28 extends through the interior of the main body 14 defining a plurality of chambers 30, 32, 34 each configured for receiving food items therein. The main body 14 may include a recessed area 36 extending around and between each of the chambers 30, 32, 34.

The lid 16 is positionable to cover the top edge 22 of the perimeter wall 20 to close the access opening 24 and cover each of the chambers 30, 32, 34. A bottom surface 40 of the lid 16 may include a downwardly projecting lip 42. The lip 42 has a size and shape to mate with the recessed area 36 to prevent the food items positioned in each chamber 30, 32, 34 from mixing with the food items positioned in an adjacent one of the chambers 30, 32, 34. One or more gaskets 43 may be positioned between the lid 16 and the main body 14 to seal the lid 16 to the main body 14. The lid 16 may be removably coupled to the main body 14, which allows the main body 14 to function as a plate without any hindrance from the lid 16 while a person eats the food items positioned in the main body 14. The lid 16 may include an upper section 44 and a lower section 46 pivotally coupled together. The lower section 46 includes a top side 48. The top side 48 may have a plurality of receptacles 50, 52, 54, 56 extending downwardly therein. The receptacles 50, 52, 54, 56 may be used to store eating utensils 96, napkins and the like therein. The upper section 44 of the lid 16 includes a bottom side 58. The bottom side 58 may have a compartment 60 extending therein.

At least one coupler, which may include a plurality of couplers 62, 63, 64, 65, is coupled to the housing 12. Each coupler 62, 63, 64, 65 includes a first mating member 66, 67, 68, 69 coupled to the main body 14 and a second mating member 70, 71, 72, 73 coupled to the lid 16. Each first mating member 62, 63, 64, 65 engages the associated second mating member 70, 71, 72, 73 to secure the main body 14 to the lid 16. At least one of the couplers 62, 63, 64, 65 is coupled to a first side 74 of the housing 12. At least one of the couplers 62, 63, 64, 65 may also be coupled to a second side 76 of the housing 12 opposite the first side 74 of the housing 12. Each of the couplers 62, 63, 64, 65 may comprise a latch. Each of the couplers 62, 63, 64, 65 is coupled to and extends from the upper section 44 of the lid 16 to the main body 14 such that the upper 44 and lower 46 sections of the lid 16 are secured together when each first mating member 62, 63, 64, 65 engages the associated second mating member 70, 71, 72, 73.

A heating element 80 is mounted within the housing 12 and is positioned below each of the chambers 30, 32, 34 for heating the food items positioned in each of the chambers 30, 32, 34. An insulating material 82 is positioned within the housing 12 to provide thermal insulation to the housing 12. A power source 84 is electrically coupled to the heating element 80 for providing power to heat the heating element 80. The power source 84 is coupled to the housing 12. The power source 84 may comprise a power port 86 coupled to the housing 12. The power port 86 electrically couples to a power cord 88 whereby the power port 86 is electrically coupled to the heating element 80. The compartment 60 in the lid 16 may be used to store the power cord 88 therein. Alternatively, or in addition to the power port 86, the power source 84 may comprise a rechargeable battery 90. One or more solar cells 92 may be electrically coupled to the battery 90 for recharging the battery 90. The solar cells 92 may be mounted on the lid 16, and more particularly, on the upper section 44 of the lid 16. A timer 94 is coupled to the housing 12. The timer 94 is electrically coupled to the power source 84 wherein manipulation of the timer 94 activates the heating element 80 for a selectable period of time.

The housing 12 may have a length extending along each of the first 74 and second 76 sides measuring between approximately 24.0 cm and 32.0 cm. The housing 12 may have a width extending between the first 74 and second 76 sides measuring between approximately 12.0 cm and 18.0 cm.

In use, food items to be warmed are placed within the chambers 30, 32, 34 and the lid 16 is closed over the top edge 22 of the perimeter wall 20. The power source 84 is used to provide electricity to heat the heating element 80. The timer 94 is set in order to control a duration of time for providing heat to the heating element 80. When the food items reach a desired temperature, the lid 16 is removed from the main body 14 in order to allow a person to eat the food items directly from the main body 14 without hindrance from the lid 16. The eating utensils, napkins and other accessories can be removed from the lid 16 and used while eating.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable heating device comprising:
a housing including;
a main body having a bottom wall and a perimeter wall attached to and extending upwardly from said bottom wall, a top edge of said perimeter wall defining an access opening into an interior of said main body;
at least one dividing wall extending through said interior of said main body defining a plurality of chambers each configured for receiving food items therein; and
a lid being positionable to cover said top edge of said perimeter wall to close said access opening and cover each said chamber;
a heating element mounted within said housing and being positioned below each of said chambers for heating the food items positioned in each of said chambers; and
a power source electrically coupled to said heating element for providing power to heat said heating element, said power source being coupled to said housing.

2. The device of claim 1, further comprising:
said main body including a recessed area extending around and between each of said chambers; and
a bottom surface of said lid including a downwardly projecting lip, said lip having a size and shape to mate with said recessed area to prevent the food items positioned in each said chamber from mixing with the food items positioned in an adjacent said chamber.

3. The device of claim 1, further comprising wherein said lid is removably coupled to said main body.

4. The device of claim 1, further comprising at least one coupler coupled to said housing, each said coupler including a first mating member coupled to said main body and a second mating member coupled to said lid, each said first mating member engaging an associated said second mating member to secure said main body to said lid.

5. The device of claim 1, further comprising a timer coupled to said housing, said timer being electrically coupled to said power source wherein manipulation of said timer activates said heating element for a selectable period of time.

6. The device of claim 1, further comprising wherein said power source comprises a power port coupled to said housing, said power port being configured for electrically coupling to a power cord whereby said power port is electrically coupled to said heating element.

7. The device of claim 1, further comprising wherein said power source comprises a rechargeable battery.

8. The device of claim 7, further comprising a solar cell electrically coupled to said rechargeable battery.

9. The device of claim 1, further comprising wherein said lid includes an upper section and a lower section, said upper section being pivotally coupled to said lower section.

10. The device of claim 9, further comprising wherein said lower section of said lid includes a top side, said top side having a plurality of receptacles extending downwardly therein.

11. The device of claim 9, further comprising:
wherein said power source comprises a power port coupled to said housing, said power port being configured for electrically coupling to a power cord whereby said power port is electrically coupled to said heating element; and
wherein said upper section of said lid includes a bottom side, said bottom side having a compartment extending therein wherein said compartment is configured for storing the power cord.

12. The device of claim 1, further comprising an insulating material positioned within said housing to provide thermal insulation to said housing.

13. The device of claim 4, further comprising wherein each said coupler comprises a latch, at least one of said couplers being coupled to a first side of said housing, at least one of said couplers being coupled to a second side of said housing opposite said first side of said housing.

14. The device of claim 4, further comprising wherein each said coupler is coupled to and extends from said upper section of said lid to said main body such that said upper and lower sections of said lid are secured together when each of said first mating members engages said associated second mating member.

15. A portable heating device comprising:
a housing including;
a main body having a bottom wall and a perimeter wall attached to and extending upwardly from said bottom wall, a top edge of said perimeter wall defining an access opening into an interior of said main body, at least one dividing wall extending through said interior of said main body defining a plurality of chambers each configured for receiving food items therein, said main body including a recessed area extending around and between each of said chambers; and
a lid being positionable to cover said top edge of said perimeter wall to close said access opening and cover each said chamber, a bottom surface of said lid including a downwardly projecting lip, said lip having a size and shape to mate with said recessed area to prevent the food items positioned in each said chamber from mixing with the food items positioned in an adjacent said chamber, said lid being removably coupled to said main body;
at least one coupler coupled to said housing, each said coupler including a first mating member coupled to said main body and a second mating member coupled to said lid, each said first mating member engaging an associated said second mating member to secure said main body to said lid, each said coupler comprising a latch, at least one of said couplers being coupled to a first side of said housing, at least one of said couplers being coupled to a second side of said housing opposite said first side of said housing, each said coupler being coupled to and extending from said upper section of said lid to said main body such that said upper and lower sections of said lid are secured together when each said first mating member engages said associated second mating member;
a heating element mounted within said housing and being positioned below each of said chambers for heating the food items positioned in each of said chambers;
an insulating material positioned within said housing to provide thermal insulation to said housing;
a power source electrically coupled to said heating element for providing power to heat said heating element, said power source being coupled to said housing; and
a timer coupled to said housing, said timer being electrically coupled to said power source wherein manipulation of said timer activates said heating element for a selectable period of time.

16. The device of claim 15, further comprising wherein said power source comprises a power port coupled to said housing, said power port being configured for electrically coupling to a power cord whereby said power port is electrically coupled to said heating element.

17. The device of claim 15, further comprising:
wherein said power source comprises a rechargeable battery; and
a solar cell electrically coupled to said rechargeable battery, said solar cell being mounted on said lid.

18. The device of claim 16, further comprising:
said lid including an upper section and a lower section, said upper section being pivotally coupled to said lower section, said lower section including a top side, said top side having a plurality of receptacles extending downwardly therein, said upper section of said lid including a bottom side, said bottom side having a compartment extending therein wherein said compartment is configured for storing the power cord;
wherein said power source comprises a rechargeable battery; and
a solar cell electrically coupled to said rechargeable battery, said solar cell being mounted on said upper section of said lid.
